(19) United States
(12) Patent Application Publication
(10) Pub. No.: US 2009/0100100 A1
(43) Pub. Date: Apr. 16, 2009

(54) SYSTEM AND METHOD FOR PLAYING MULTIMEDIA FILES AT A WORKSTATION IN A PRODUCTION LINE

(75) Inventors: FU-CHUAN CHU, Tu-Cheng (TW); YANG-CHUAN HSIAO, Tu-Cheng (TW)

Correspondence Address: PCE INDUSTRY, INC.;ATT. Steven Reiss, 458 E. LAMBERT ROAD, FULLERTON, CA, 92835, US

(73) Assignee: HON HAI PRECISION INDUSTRY CO., LTD., Tu-Cheng (TW)

(21) Appl. No.: 12/233,541

(22) Filed: Sep. 18, 2008

(30) Foreign Application Priority Data
Oct. 16, 2007 (CN) 200710202076.2

(51) Int. Cl. G06F 17/30

(52) U.S. Cl. 707/104.1; 707/E17.009

(57) ABSTRACT

A computer-based method for playing multimedia files at a workstation in a production line is disclosed. The method comprises: (a) detecting periodically if a current time has reached a scheduled play time to play one or more multimedia files according to a play file schedule stored in a storage system at the workstation; (b) in response to the current time reaching the scheduled play time, downloading the multimedia files from a database system to the storage system upon condition that the multimedia file does not exit in the storage system; (c) playing the multimedia file via a display device.

### BACKGROUND

1. Field of the Invention

Embodiments of the present disclosure relate to remote controlling systems and methods, and more particularly to a system and method for playing multimedia files at a workstation in a production line.

2. Description of Related Art

A production line is a set of sequential operations established in a factory where materials and/or components are put through a refining process and/or assembled to produce an end-product.

In order to improve productivity in a production line, various workstations are disposed along the production line. Each of the workstations refers to a particular operation, such as cutting, welding, testing, for example, to produce an end-product. Before starting operation, operators in each of the workstations need to read one or more operation guides/manuals such as a standard operating procedure (SOP), memos and other information related to the production specification. However, presently, the operation guides are generally printed on one or more pieces of papers located in a particular area which may not be readily accessible. Additionally, these operation guides may be difficult to understand and thus may require multiple views because the operator may easily forget information from these operation guides.

Therefore, what is needed is an improved and more readily accessible system to for viewing an operation guide.

### SUMMARY

A system for playing multimedia files at a workstation in a production line is disclosed. The system comprises a determining module, a downloading module and a playing module. The determining module is configured for periodically detecting if a current time has reached a scheduled play time to play the one or more multimedia files according to a play file schedule stored in a storage system at the workstation, and if a multimedia file exists in the storage system. The downloading module is configured for downloading the multimedia file from a database system to the storage system at the workstation upon condition that the multimedia file does not exist in the storage system. The playing module configured for playing the one or more multimedia files and displaying the contents of the one or more multimedia files via a display device. At least one processor executing the determining module, the downloading module and the playing module.

Other advantages and novel features will become more apparent from the following detailed description certain embodiments of the present disclosure when taken in conjunction with the accompanying drawings.

### BRIEF DESCRIPTION OF THE DRAWINGS

FIG. 1 is a block diagram of one embodiment of a system for playing multimedia files at a workstation in a production line;

FIG. 2 is a block diagram of one embodiment of a computer in FIG. 1; and

FIG. 3 is a flowchart of one embodiment of a method for playing multimedia files at a workstation in a production line.

### DETAILED DESCRIPTION OF CERTAIN INVENTIVE EMBODIMENTS

All of the processes described below may be embodied in, and fully automated via, software code modules executed by one or more general purpose computers or processors. The code modules may be stored in any type of computer-readable medium or other computer storage device. Some or all of the methods may alternatively be embodied in specialized computer hardware.

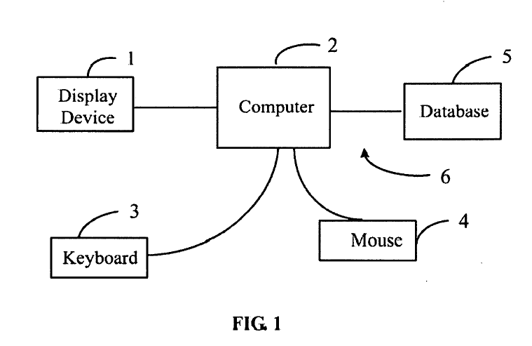

FIG. 1 is a block diagram of one embodiment of a system 6 for playing multimedia files at a workstation in a production line. One or more multimedia files may be played by an assigned operator of the workstation in the production line in response to a selected time. The system 6 may comprise a computer 2 comprising a plurality of peripherals and devices electronically connected to the computer 2. In one embodiment, the computer 2 may be electronically connected to a display device 1, a keyboard 3, and a mouse 4 in order to input/output various computer signals or interfaces to a user. The computer 2 may be a personal computer (PC), a network server, or any other appropriate data-processing equipment. The database system 5 is used for storing the multimedia files, a play file schedule, and other information, such as information of operator at the workstation. As used herein, the term, “multimedia files” refers to videos and pictures in one or more file formats/types, such as .SWF, .MOV, .MP3, .MP4, .WMV, .AVI, .OOG, .RM, .JPG, .GIF, .TIFF, .PNG, for example. In one embodiment, the multimedia files may comprise information about standard operating procedures (SOP), manuals, and other information related to production specification.

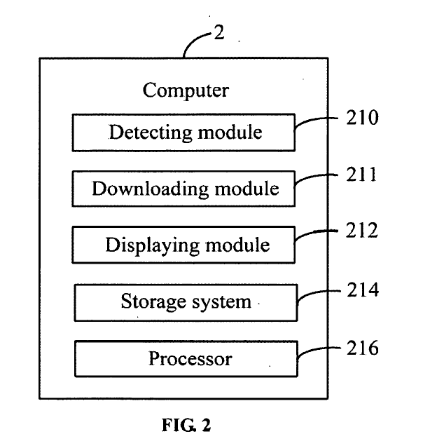

FIG. 2 is a block diagram of one embodiment of the computer 2 in FIG. 1. In one embodiment, the computer 2 comprises a determining module 210, a downloading module 211, and a playing module 212. The modules 210, 211, 212 may be used to execute one or more operations for the computer 2. Accordingly, the one or more multimedia files may be stored in a storage system 214 of the computer 2 in addition to other various files. A processor 216 may be used to execute one or more operations of the modules 210, 211, 212.

The determining module 210 is configured for determining if an operator at a workstation is an assigned operator by validating the identity of the employee. In one embodiment, the employee ID of the operator, such as a staff badge ID, may be inputted into the computer 2 via the keyboard 3 or other input device. The determining module 210 then compares the staff badge ID inputted with the information of the assigned operator stored in the database system 5, and validates if operator card number is an assigned operator.

In one embodiment, the play file schedule stores information about one or more multimedia files to be played. In one embodiment, the information may comprise a name of each multimedia file and a scheduled time to play the multimedia file, such as “nano_imprinting.mov, 9:00 am.”. The determining module 210 is further configured for periodically detecting if a current time has reached the scheduled play time according to the play file schedule. In one embodiment, a user may set a scheduled play time for starting a program for playing one or more the multimedia files according to the play file schedule. For example, if a multimedia file is scheduled to be played by the computer 2 at 9:00 A.M. during the work days, the user may set the play time for starting the program at 9:00 A.M.. The determining module 210 detects if the current time has reached at 9:00 A.M.. If the current time is 9:00 A.M., the program for playing the multimedia file is executed.

The determining module 210 is also configured for determining if one or more multimedia files to be played is stored in the storage system 214.

The downloading module 211 is configured for downloading the one or more multimedia files from the database system 5 to the storage system 214 if the one or more multimedia file does not exist in the storage system 214. The database system 5 may be a networked drive connected to the computer 2 via a network connection, such as the Internet or through a local area network (LAN), for example.

The playing module 212 is configured for playing the one or more multimedia files and displaying the contents of the one or more multimedia files via the display device 1.

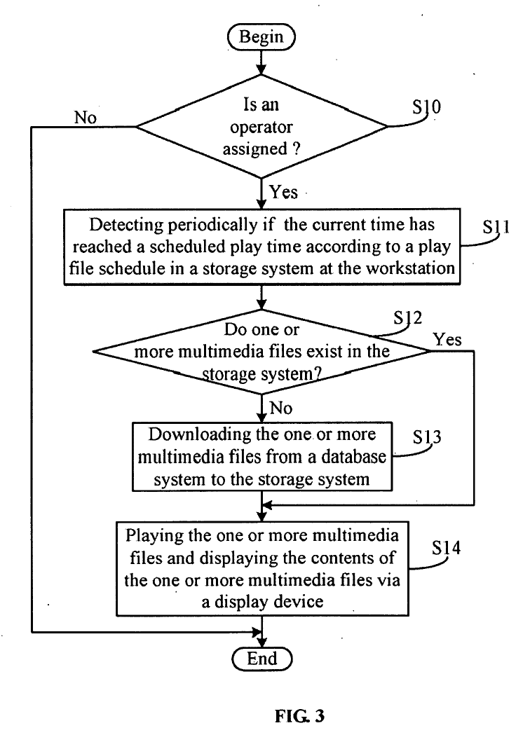

FIG. 3 is a flowchart of one embodiment of a method for playing one or more selected multimedia files at a workstation in a production line. In block S10, the determining module 210 determines if an operator at the workstation is an assigned operator by validating the identity of the employee.

If the operator is not the assigned operator, the procedure ends. Otherwise, if the operator is the assigned operator, in block S11, the determining module 210 periodically detects if a current time has reached the scheduled play time according to the play file schedule. In one embodiment, the play file schedule stores information about playing the multimedia files, e.g., a name of each multimedia file, and a scheduled time to play the multimedia file.

If the current time reaches the scheduled play time corresponding to the multimedia file, in block S12, the determining module 210 further determines if the one or more multimedia files to be played is stored in the storage system 214.

If the one or more multimedia files exist in the storage system 214, the procedure turns to block S14. Otherwise, if the one or more multimedia files do not exist in the storage system 214, in block S13, the downloading module 211 downloads the one or more multimedia files from the database system 5 to the storage system 214.

In block S14, the playing module 213 plays the one or more multimedia files and displays the contents of the one or more multimedia files via a display device 1.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A system for playing one or more multimedia files at a workstation in a production line, the system comprising:
a determining module configured for periodically detecting if a current time has reached a scheduled play time to play the one or more multimedia files according to a play file schedule stored in a storage system at the workstation, and if a multimedia file exists in the storage system;
a downloading module configured for downloading the multimedia file from a database system to the storage system at the workstation upon condition that the multimedia file does not exist in the storage system;
a playing module configured for playing the one or more multimedia files and displaying the contents of the one or more multimedia files via a display device; and
at least one processor executing the determining module, the downloading module and the playing module.

2. The system according to claim 1, wherein the determining module is further configured for validating an identity of an operator working at the workstation.

3. The system according to claim 1, wherein the one or more multimedia files are selected from the group consisting of an operation guide, an operation manual, a standard operating procedure (SOP), and a memo.

4. The system according to claim 3, wherein the one or more multimedia files comprises a file type selected from the group consisting of .SWF, .MOV, .MP3, .MP4, .WMV, .AVI, .OOG, .RM, .JPG, .GIF, .TIFF, and .PNG.

5. A computer-based method for playing one or more multimedia files at a workstation in a production line, the method comprising:
(a) detecting periodically if the current time reaches a play time to play a multimedia file according to a play file schedule stored in a storage system at the workstation;
(b) in response to a current time reaching a scheduled play time, downloading the one or more multimedia files from a database system to the storage system upon condition that the multimedia file does not exit in the storage system; and
(c) playing the one or more multimedia files and displaying the contents of the one or more multimedia files via a display device.

6. The method according to claim 5, further comprising:
validating an identity of an operator working at the workstation before block (a).

7. The method according to claim 5, wherein the one or more multimedia files are selected from the group consisting of an operation guide, an operation manual, a standard operating procedure (SOP), and a memo.

8. The method according to claim 7, wherein the one or more multimedia files comprises a file type selected from the group consisting of .SWF, .MOV, .MP3, .MP4, .WMV, .AVI, .OOG, .RM, .JPG, .GIF, .TIFF, and .PNG.

9. A computer-readable medium having stored thereon instructions for playing multimedia files at a workstation in a production line, comprising a plurality of components, the computer-readable medium, when executed by a computer, causing the computer to perform a method, the method comprising:
(a) detecting periodically if the current time reaches a play time to play a multimedia file according to a play file schedule stored in a storage system at the workstation;
(b) in response to a current time reaching a scheduled play time, downloading the one or more multimedia files from a database system to the storage system upon condition that the multimedia file does not exit in the storage system; and
(c) playing the one or more multimedia files and displaying the contents of the one or more multimedia files via a display device.

10. The medium as claimed in claim 9, wherein further comprising:
validating an identity of an operator working at the workstation before block (a).

11. The medium according to claim 9, wherein the one or more multimedia files are selected from the group consisting of an operation guide, an operation manual, a standard operating procedure (SOP), and a memo.

12. The medium according to claim 11, wherein the one or more multimedia files comprises a file type selected from the group consisting of .SWF, .MOV, .MP3, .MP4, .WMV, .AVI, .OOG, .RM, .JPG, .GIF, .TIFF, and .PNG.
